(19) United States
(12) Patent Application Publication
(10) Pub. No.: US 2017/0010851 A1
(43) Pub. Date: Jan. 12, 2017

(54) Device, System, and Method for Automated Control

(71) Applicant: Avaya Inc., Santa Clara, CA (US)

(72) Inventors: Rahul BUDDHISAGAR, Milpitas, CA (US); Michael Krack, St. Pete Beach, FL (US); Jai Pugalia, San Jose, CA (US); Jeffrey Wong, San Jose, CA (US); Wayne Wong, Milpitas, CA (US)

(21) Appl. No.: 14/792,229

(22) Filed: Jul. 6, 2015

(51) Int. Cl. G06F 3/16; H04M 3/02; H04L 12/58; H04W 68/00

(52) U.S. Cl. CPC G06F 3/16; H04W 68/005; H04M 3/02; H04L 51/24

(57) ABSTRACT

An electronic device, system, and method performs an automated control. The electronic device includes an audio output device configured to play a sound. The electronic device includes a processor configured to receive state data indicative of a state of a user of the electronic device. The processor is configured to control an activation of the audio output device based upon the state data. The activation of the audio output device is based upon first setting data when the state data indicates a first state. The activation of the audio output device is based upon second setting data when the state data indicates a second state.

### BACKGROUND INFORMATION

An electronic device may include a plurality of hardware and software for a variety of functionalities to be performed and applications to be executed. During a course of using a functionality or an application by a user, one or more hardware components besides the processor and memory may be used. For example, a display device may be used to show a user interface to the user or an audio output device may be used to generate audio for the user. Furthermore, there may be a functionality or an application that is activated outside a control of the user such as a call application in which an incoming call may activate the call application or a messaging application in which a message is received without any user interaction. When such operations are performed, the audio output device may be configured to generate a predetermined audio sound.

The electronic device may include a variety of options to set the manner in which the audio output device is used. For example, the user may set specific predetermined audio sounds to play at different occasions. In another example, the electronic device may include a mute option in which the audio output device is deactivated. The mute option may be activated specifically prior to the user sleeping. Accordingly, the mute option may be deactivated to re-activate the audio output device. The process in which the mute option is used is either a scheduled operation at a fixed time each day or the user must manually activate/deactivate the mute option. However, the scheduled operation does not accommodate variations in sleep times and is inflexible. The manual operation may also include drawbacks such as if the user remembers to activate the mute option but forgets to deactivate the mute option that may result in subsequent incoming calls or notifications to be ignored due to a lack of audio output sounds.

### SUMMARY OF THE INVENTION

The present invention describes an electronic device comprising: an audio output device configured to play a sound; and a processor configured to receive state data indicative of a state of a user of the electronic device, the processor configured to control an activation of the audio output device based upon the state data, the activation of the audio output device being based upon first setting data when the state data indicates a first state, the activation of the audio output device being based upon second setting data when the state data indicates a second state.

The present invention describes a method comprising: receiving state data indicative of a state of a user of the electronic device; and controlling an activation of an audio output device of the electronic device based upon the state data, the activation of the audio output device being based upon first setting data when the state data indicates a first state, the activation of the audio output device being based upon second setting data when the state data indicates a second state.

The present invention describes a system comprising: a first electronic device of a user including an audio output device configured to play a sound and a first transceiver; and a second electronic device configured to monitor information of the user, the second electronic device including a second transceiver, the first and second transceivers configured to establish a connection between the first and second electronic devices one of directly and through a communications network, wherein the second electronic device transmits the monitored information of the user to the first electronic device via the connection, wherein the first electronic device is configured to determine state data of the user based upon the monitored information, the state data indicative of a state of the user, the state being one of asleep and awake, wherein the first electronic device is configured to control an activation of the audio output device based upon the state data, the activation of the audio output device being based upon first setting data when the state data indicates a first state, the activation of the audio output device being based upon second setting data when the state data indicates a second state.

### BRIEF DESCRIPTION OF THE DRAWINGS

FIG. 1 shows an exemplary system according to the present invention.

FIG. 2 shows an exemplary electronic device according to the present invention.

FIG. 3 shows an exemplary method of automatically controlling an audio output device according to the present invention.

### DETAILED DESCRIPTION

The exemplary embodiments may be further understood with reference to the following description and the related appended drawings, wherein like elements are provided with the same reference numerals. The exemplary embodiments are related to a device, system, and method for an automated control. Specifically, the exemplary embodiments provide a mechanism in which an audio output device of an electronic device is automatically controlled for operation for select or all applications of the electronic device. The exemplary embodiments may provide the mechanism to be based upon a state of the user of the electronic device. The automated audio control, the audio output device, the electronic device, the applications, the state, and a related method will be described in further detail below.

Initially, it should be noted that the exemplary embodiments are described herein with regard to an automatic control of an audio output device. However, this is only exemplary. Those skilled in the art will appreciate that the exemplary embodiments may be applied to controlling any aspect (e.g., a device, a functionality, etc.) based upon the state of the user.

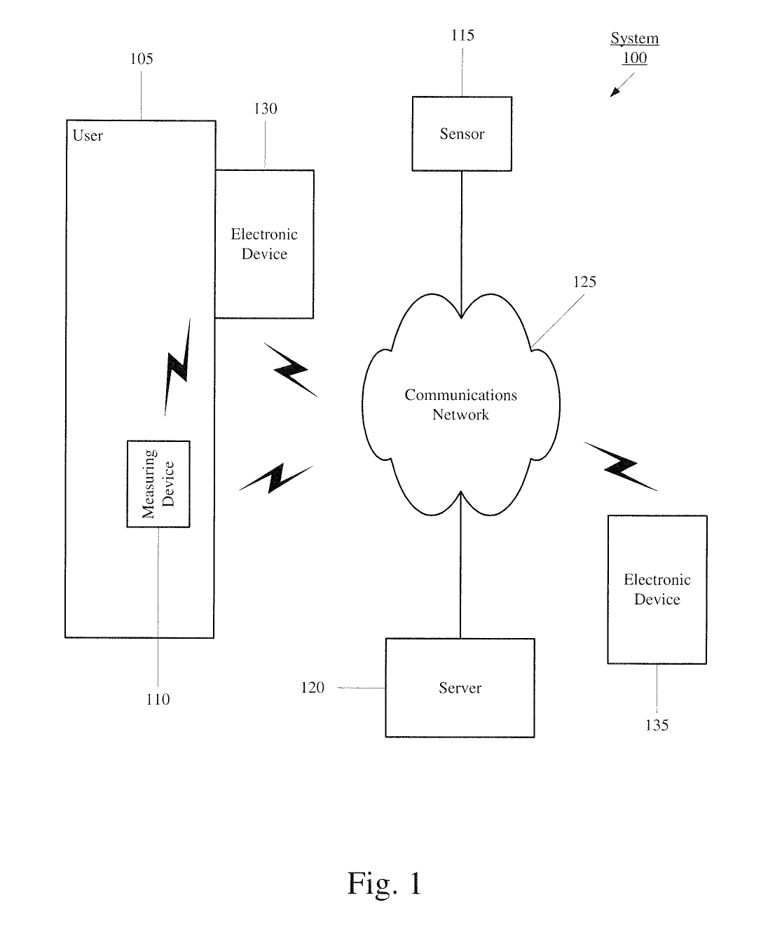

FIG. 1 shows an exemplary system 100 according to the present invention. The system 100 may incorporate one or more manners of measuring a state of a user 105 and utilizing the data of the state for the automated audio control functionality. The system 100 may also include any manner for data exchange between the various devices therein. The system 100 may include a measuring device 110 on the user 105, a sensor 115, a server 120, a communications network 125, an electronic device 130, and a further electronic device 135.

The measuring device 110 may be any device configured to measure bodily functions or determine information of the user 105 regarding the state of the user 105. For example, the measuring device 110 may monitor various body measurements such as heart rate, temperature, etc. Accordingly, the measuring device 110 may be a fitness band, a smartwatch, etc. The measuring device 110 may therefore include all necessary hardware and software to perform these functionalities. The measuring device 110 may be disposed in a variety of locations to perform these functionalities. For example, the hardware of the measuring device 110 may require a direct contact on the user 105 (as illustrated in the system 100) for select monitoring functionalities such as a temperature reading. In another example, the hardware of the measuring device 110 may be configured to be adjacent or substantially near the user 105 for select monitoring functionalities. Those skilled in the art will understand that this may be accomplished using any known manner of body monitoring.

The measuring device 110 may further be configured to process the information being monitored and determine other information of the user. For example, the measuring device 110 may be configured to determine the state of the user 105. The state of the user 105 will be described in further detail below. It should be noted that this capability of the measuring device 110 is only exemplary. In another embodiment, the measuring device 110 may only transmit the data being monitored to a further device such that the state may be determined by this further device.

The measuring device 110 may further include a transceiver or other communication device that enables data to be transmitted (hereinafter collectively referred to as a “transceiver”). As noted above, the information being monitored and/or the determined state of the user may be transmitted. This functionality may be performed via the transceiver. As illustrated in the system 100 of FIG. 1, the measuring device 110 may transmit data to a variety of devices such as to the electronic device 130. The measuring device 110 may also be associated with the communications network 125 to enable a data transmission to any device connected thereto such as the server 120. Although the measuring device 110 is illustrated with a wireless communication capability, this is only exemplary. The measuring device 110 may also be configured with a wired communication capability or a combination of wired and wireless communication capability.

The sensor 115 may also be any device configured to measure bodily functions or determine information of the user 105 regarding the state of the user 105. Accordingly, the sensor 115 may be substantially similar to the measuring device 110 in functionality. However, the mechanism by which the sensor 115 operates may differ from the measuring device 110. For example, the sensor 115 may be disposed substantially remote from the user 105. Accordingly, the sensor 115 may utilize different hardware and software to monitor the user 105 such as thermal sensors to measure temperature of the user 105 (in contrast to a direct contact measurement that may be used by the measuring device 110). The sensor 115 may also be configured with a transceiver configured to exchange data. As illustrated, the sensor 115 is shown having a wired connection to the communications network 125. However, this is only exemplary. The sensor 115 may also be configured with a wireless communication capability or a combination of wired and wireless communication capability as well as being connected or associated with other devices such as the electronic device 130. Like the measuring device 110, the sensor 115 may also be configured to determine the state of the user 105 and/or provide monitored information of the user 105 to a further device.

The server 120 may be a device configured to receive data from the measuring device 110 and/or the sensor 115. As discussed above, the measuring device 110 and/or the sensor 115 may determine the state of the user 105. The data corresponding to the state of the user 105 may be transmitted to the server 120. Also as discussed above, the measuring device 110 and/or the sensor 115 may transmit monitored data of the user 105. The monitored data of the user 105 may be transmitted to the server 120. Accordingly, the server 120 may represent the further electronic device described above that is configured to determine the state of the user 105 based upon the received monitored information.

The server 120 is illustrated in the system 100 as having a wired connection to the communications network 125. However, in a substantially similar manner as the measuring device 110 and the sensor 115, the server 120 may utilize a wired communication functionality, a wireless communication functionality, or a combination thereof. Furthermore, in a substantially similar manner as the measuring device 110 and the sensor 115, the use of the communications network 125 is only exemplary. That is, the communications network 125 being used as an intermediary for data to be exchanged between devices is only exemplary. For example, the wired and/or wired communication functionality may be used directly between the measuring device 110 with the server 120, the sensor 115 with the server 120, the measuring device 110 with the electronic device 130, the server 120 with the electronic device 130, etc.

The communications network 125 may be any type of network that enables data to be transmitted from a first device to a second device where the devices may be a network device and/or an edge device that has established a connection to the communications network 125. For example, the communications network 125 may be a local area network (LAN), a wide area network (WAN), a virtual LAN (VLAN), a WiFi network, a HotSpot, a cellular network, a cloud network, a wired form of these networks, a wireless form of these networks, a combined wired/wireless form of these networks, etc. The communications network 125 may also represent one or more networks that are configured to connect to one another to enable the data to be exchanged among the components of the system 100.

As discussed above, the state of the user 105 may be determined by a variety of different devices of the system 100 such as the measuring device 110, the sensor 115, the server 120, etc. The state of the user may relate to whether the user 105 is in an awake state or in an asleep state. That is, the state may relate to a condition when the user 105 utilizes the electronic device 130 or a condition when the user 105 will not utilize the electronic device 130. Therefore, the state of the user 105 may provide a high probability of when an audio output device of the electronic device 130 is to be utilized (with exceptions to be discussed below). It should be noted that the state of the user 105 being a wake or sleep state is only exemplary. Those skilled in the art will understand that the exemplary embodiments may also be utilized for a first state and a second state where these states may relate to any condition of the user 105. For example, the first state may be a normal state where the user 105 has ordinary body functions (e.g., resting heart rate) and the second state may be an abnormal state where the user 105 is experiencing different body functions (e.g., rapid heart rate, increased blood pressure, etc.)

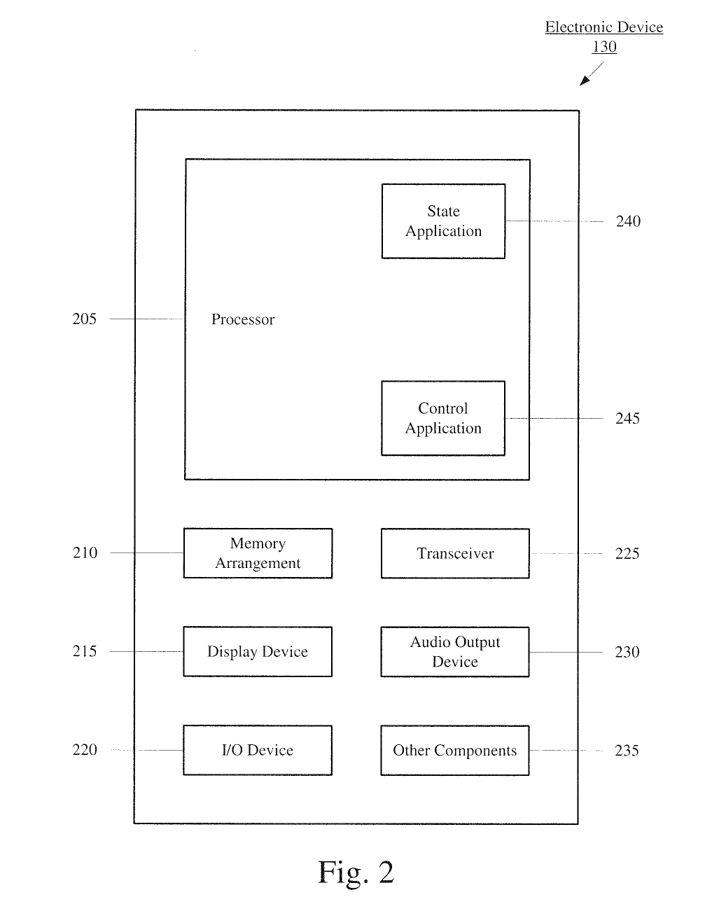

FIG. 2 shows the exemplary electronic device 130 of FIG. 1 according to the present invention. The electronic device 130 may be a device that is associated with the user 105 and used by the user 105. The electronic device 130 may represent any device that is configured to perform a plurality of functionalities including the functionalities described herein. For example, the electronic device 130 may be a portable device such as a tablet, a laptop, a smart phone, a wearable, etc. Although the exemplary embodiments described herein relate to the electronic device 130 being a portable device, those skilled in the art will understand that the exemplary embodiments may also be utilized when the electronic device 130 is a stationary device such as a desktop terminal. The electronic device 130 may include a processor 205, a memory arrangement 210, a display device 215, an input/output (I/O) device 220, a transceiver 225, an audio output device 230, and other components 235 (e.g., an audio input device, a battery, a data acquisition device, ports to electrically connect the electronic device 130 to other electronic devices, etc.).

The processor 205 may be configured to execute a plurality of applications of the electronic device 130. For example, the processor 205 may execute a browser application when connected to the communications network 125 via the transceiver 225. In another example, the processor 205 may execute an alarm application that is configured to play a sound via the audio output device 230 at a predetermined time. In yet another example, the processor 205 may execute a call application that is configured to establish a communication with the user 105 and a further user using a different electronic device. In a further example, according to the exemplary embodiments, the processor 205 may execute a state application 240. The state application 240 may be configured to receive the state data from the various components of the system 100 such as the measuring device 110, the sensor 115, and the server 120 (if these components are configured to determine the state of the user 105). As discussed above, the electronic device 130 may also be the further electronic device that is configured to determine the state. Accordingly, the state application 240 may provide this functionality by receiving the monitored data from the measuring device 110, the sensor 115, etc. In a still further example, according to the exemplary embodiments, the processor 205 may execute a control application 245. The control application 245 may be configured to control the manner in which the audio output device 230 is used by the various applications of the electronic device 105 based upon the state of the user 105 where these applications may utilize the audio output device 230 (e.g., the call application playing a sound to indicate an incoming call).

It should be noted that the above noted applications, each being an application (e.g., a program) executed by the processor 205, is only exemplary. The functionality associated with the applications may also be represented as a separate incorporated component of the electronic device 130 or may be a modular component coupled to the electronic device 130, e.g., an integrated circuit with or without firmware.

The memory arrangement 210 may be a hardware component configured to store data related to operations performed by the electronic device 100. Specifically, the memory arrangement 210 may store data related to the state application 240 and/or the control application 245. For example, the settings to control the audio output device 230 may be stored in the memory arrangement 210. The settings may indicate whether the audio output device 230 is to be activated or deactivated based upon the state of the user 105. The settings may also indicate whether any exceptions are included that may enable the audio output device 230 to remain activated for select events while other events have the audio output device 230 deactivated.

The display device 215 may be a hardware component configured to show data to a user while the I/O device 220 may be a hardware component that enables the user to enter inputs. For example, the display device 215 may show a user interface while the I/O device 220 may enable inputs to be entered regarding the settings to be used for the control application 245. It should be noted that the display device 215 and the I/O device 220 may be separate components or integrated together such as a touchscreen. The transceiver 225 may be a hardware component configured to transmit and/or receive data in a wired or wireless manner. It is again noted that the transceiver 225 may be any one or more components that enable the data exchange functionality to be performed via a direct connection such as with the measuring device 110 and/or a network connection with the communications network 125. The audio output device 230 may be any sound generated component.

According to the exemplary embodiments, the state application 240 may utilize the state of the user 105 to indicate to the control application 245 the manner of controlling the audio output device 230. Whether the state application 240 is to determine the state from the monitored information that is received or simply receives the state from a previous determination by a different device, the state application 240 may process the state data to generate a corresponding signal to the control application 245. In this manner, the exemplary embodiments provide a mechanism to intelligently determine whether the user 105 is asleep and a predetermined set of notifications or settings may silence the electronic device automatically (e.g., deactivating the audio output device 230 when activation is otherwise intended). Furthermore, the exemplary embodiments may detect when the user 105 is awake such that the electronic device 105 may be automatically unmuted.

The mute/unmute mechanism of the exemplary embodiments may be used in a variety of manners. In a first exemplary embodiment, the state application 240 and the control application 245 may utilize the audio output device 230 based strictly on the state of the user 105. Specifically, a setting may be stored in the memory arrangement 210 where the audio output device 230 is completely deactivated while the state of the user 105 is determined to be asleep. Thus, when the state application 240 generates a signal for the control application 245 that the user 105 is asleep, the control application 245 may deactivate the audio output device 230. It should be noted that the deactivation of the audio output device 230 may be an overriding feature where an application may request the use of the audio output device 230 but the signal from the control application 245 prevents any use of the audio output device 230. In another example, the audio output device 230 may actually be deactivated by disconnecting the audio output device 230 (e.g., via switches). At a subsequent time, the state of the user 105 may be determined to be awake. Accordingly, the state application 240 generates a signal for the control application 245 that the user 105 is awake such that the control application 245 activates the audio output device 230. In this manner, the audio output device 230 may be controlled strictly based upon the state of the user 105 with no exceptions.

In a second exemplary embodiment, the state application 240 and the control application 245 may utilize the audio output device 230 in a selective manner. The selective manner may relate to the settings being updated such that the user 105 may select certain applications as exceptions to the mute/unmute mechanism of the exemplary embodiments. In a first example, the alarm application described above may be exempted from the mute operation when the user 105 is asleep. Thus, even though the state application 240 generates a signal that the user 105 is asleep, the control application 245 may mute the electronic device 130 except for the alarm application which remains allowed to use the audio output device 230. The alarm application being an exception may be a predetermined selection as a muting of this application while the user 105 is asleep is opposite to its intent. In a second example, the selective manner may enable a user selected application that is an exception. For example, for some reason, the call application may be selected to remain unmuted even while the user 105 is asleep. Thus, all other applications that are not designated as an exception may be muted when a determination is made that the state of the user 105 is asleep (as controlled via the automatic operation of the state application 240 and the control application 245) and then unmuted when a determination is made that the state of the user 105 is awake (again as controlled via the automatic operation of the state application 240 and the control application 245).

In a third exemplary embodiment, the state application 240 and the control application 245 may utilize the audio output device 230 in a manually predetermined manner. The manually predetermined manner may relate to the settings being updated such that predetermined operations as provided by the user 105 is an exception to the mute/unmute mechanism of the exemplary embodiments. In a first example, within the call application, an incoming call from predetermined further users may be entered as exceptions for the mute operation. For example, the predetermined further users such as a parent, a spouse, a child, etc. may be manually provided (or automatically determined) to be an exception to the mute operation. Thus, when a call from a parent of the user 105 is incoming while the user 105 is asleep, the audio output device 230 may still be used by the call application. However, when a call from a friend of the user 105 (or some other further user) who is not entered as an exception is incoming while the user 105 is asleep, the audio output device 230 may be prevented from being used by the call application. In a second example, a social media application may be configured to play a sound whenever an update is registered. The user 105 may have predetermined further users on the social media application whose updates will still be allowed to play the sound. Thus, when there is an update from an entered further user who is an exception while the user 105 is asleep, the mute operation may be suspended and the audio output device 230 may still be used by the social media application. However, when there is an update from a non-entered further user who is not an exception while the user 105 is asleep, the mute operation may be in effect and the audio output device 230 may be prevented from being used by the social media application.

In a fourth exemplary embodiment, the state application 240 and the control application 245 may utilize a combination of the selective manner and the manually predetermined manner. For example, a particular application and a particular operation may be exceptions to the mute/unmute mechanism of the exemplary embodiments.

It should be noted that the exceptions in any of the examples described above or as a separate form of exceptions may also incorporate other types. For example, a dynamic exception list may be included. The dynamic exception list may utilize a set of rules or settings that enable the exceptions to be dynamically determined in contrast to a predetermined manner. That is, the dynamic exception list may be a user-defined rule that when satisfied may allow a notification to occur (i.e., the audio output device 230 from being used) despite the mute operation being used. For example, a rule may relate to a call/message from a common caller/sender being received at least a predetermined number of times within a predetermined time period that enables a most recent call/message from this caller/sender to bypass the mute operation so that the audio output device 230 is used. In a specific embodiment, the mute operation may be used since the user is determined to be asleep. A call may originate from an emergency room of a hospital which is not associated with any exception. A second and third call may again originate from the emergency room within a five minute span. The rule for the dynamic exception may be whether at least three calls are received from a common user within a ten minute window. As this rule has been satisfied, the third call from the emergency room at the five minute mark may result in the audio output device 230 being used. As this is a dynamic exception, any subsequent call from the emergency room may continue to utilize the audio output device 230 for a predetermined exception time period.

Those skilled in the art will understand that the electronic device 130 may include a “silent mode” in which the audio output device 230 is effectively deactivated. The silent mode may also entail notifications being provided by a vibration component using a vibrating functionality. The electronic device 130 may accordingly be used with only the audio functionality, with only the vibrating functionality, without either, and with a combination thereof. The vibrating functionality may be incorporated into the exemplary embodiments in a variety of manners.

In a first example, as discussed above, the vibration component may be substantially similar in operation to the audio output device 230. That is, the exemplary embodiments may be used in which the vibration component is activated/deactivated based upon the state of the user 105 in a substantially similar manner as discussed above with the audio output device 230. Furthermore, because the vibration component may be associated with the silent mode, the vibration component may operate in an opposite fashion as the audio output device 230. That is, when the user 105 is determined to be in the wake state, the vibration component may be deactivated and when the user 105 is determined to be in the sleep state, the vibration component may be activated.

In a second example, the vibrating functionality may be used based upon further settings in addition to those used for the audio output device 230. Thus, the use of the vibrating functionality may be performed in a variety of different ways. For example, if the user 105 is in the sleep state, the state application 240 and the control application 245 may determine whether the vibrating functionality is activated (e.g., the user 105 may have manually activated the vibrating functionality prior to falling asleep). If the vibrating functionality were an exception that is to remain activated even when the user 105 is in the sleep state, the electronic device 130 may maintain the vibrating component in an activated state. In another example, if the user 105 is in the sleep state, the state application 240 and the control application 245 may determine whether the vibrating functionality is intended to be activated when the audio output device 230 is deactivated. Accordingly, when the user 105 goes from the wake state to the sleep state (and the vibrating functionality is determined to be deactivated), the control application 245 may be configured to activate the vibrating functionality and the vibration component.

Returning to the system 100, there may also be a further electronic device 135. The further electronic device 135 may be a device that is used by a further user (not shown) and effectively paired with the electronic device 130 of the user 105. For example, the electronic device 130 may be associated with the user 105 while the further electronic device 135 may be associated with a spouse of the user 105. The electronic device 130 and the further electronic device 135 may be associated for any reason. According to the exemplary embodiments, the pairing of the electronic device 130 with the further electronic device 135 may provide a further basis for which the state of the user 105 may be inferred. Specifically, the further electronic device 135 may determine the state of the further user. The pairing may imply that when the further user is awake, the user 105 is also awake or when the further user is asleep, the user 105 is asleep. In this manner, the state of the further user may provide the basis by which the state application 240 and the control application 245 of the electronic device 130 for the user 105 determines the manner of controlling the audio output device 230. Thus, the exemplary embodiments may further incorporate a scenario where the state of the user 105 is not used directly to determine the manner of use of the audio output device 230. For example, the measuring device 105 and/or the sensor 115 may have malfunctioned, is incapable of monitoring the user 105, is incapable of determining the state of the user 105, etc. The state of the further user may provide a backup (or primary) basis to determine the status of the audio output device 230.

It should be noted that the determination of the state may utilize various features to more accurately determine whether the user is awake or asleep. For example, a neural network may be used that may be a learning application that gathers data on the user 105. With further data that is particular to the user 105, the determination of the state may be performed with a higher accuracy to minimize or eliminate inadvertent mute/unmute operations from a misinterpreted change in state of the user 105.

It should also be noted that the state application 240 and the control application 245 may be subject to various conditions. For example, the user 105 may be prone to waking for a brief moment only to fall asleep again. The state of the user 105 may be determined to be awake during this brief moment which causes the electronic device 130 to be unmuted although the user 105 is asleep. Thus, the conditions that may be applied is that the action to mute or unmute the electronic device 130 may be subject to a predetermined minimum number of hours that the user 105 has been asleep or subject to a minimum number of minutes that the user 105 is awake.

It should further be noted that the state application 240 and the control application 245 may utilize a service feature. The service feature may be triggered when the user 105 is determined to be in a wake state for at least a predetermined time period. That is, the service feature may not be used during the above described brief moments of a wake state. If the user 105 is determined to be awake for the prerequisite time period, the service feature may trigger an alert or other notification of calls, messages, events, etc. that were missed while the user 105 was in the sleep state.

The exemplary embodiments may also utilize a timing factor for which the state of the user 105 is determined or monitored. In a substantially similar manner, the state application 240 may determine the state of the user 105 to generate the signal for the control application 245 in a variety of manners based upon time. In a first example, the state application 240 may request the monitored information and/or the state data (as determined by the further device) from the measuring device 110 and/or the sensor 115 at predetermined times. For example, the request may be transmitted at predetermined intervals to determine whether there is any change in the state of the user 105. The intervals may be any duration such as every minute, every 5 minutes, every 10 minutes, etc. In a second example, the state application 240 may receive the monitored information and/or the state data whenever a change is determined by the measuring device 110 and/or the sensor 115. For example, when the measuring device 110 registers a change in temperature (beyond a predetermined amount) or a change in heart beat (beyond a predetermined amount), the state application 240 may receive the monitored information. In a third example, the state application 240 may continuously receive monitored information and/or state data from the measuring device 110 and/or the sensor 115.

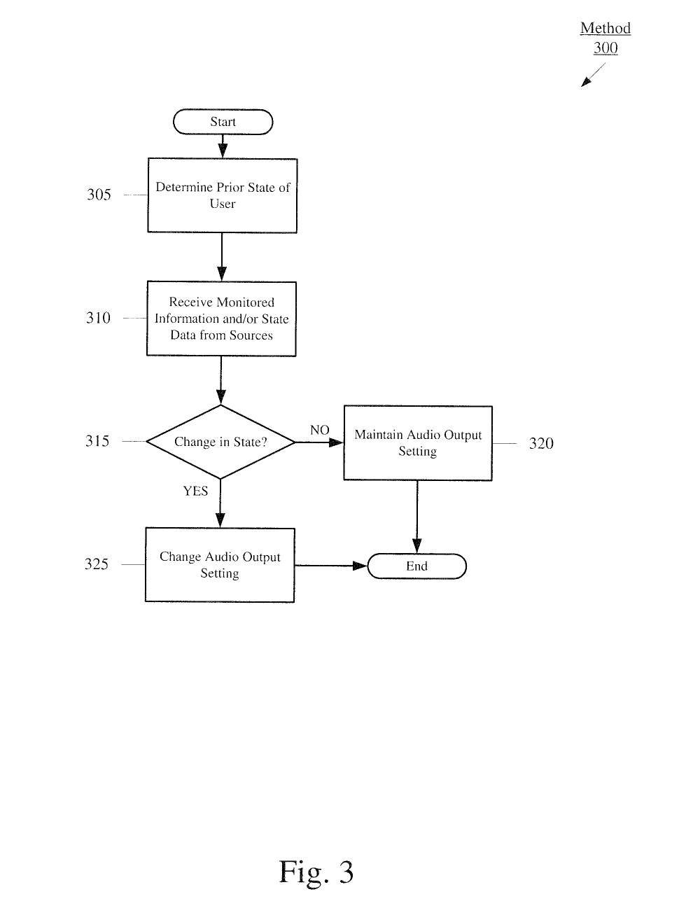

FIG. 3 shows an exemplary method 300 of automatically controlling the audio output device 230 according to the present invention. Specifically, the method 300 may relate to the electronic device 130 receive monitored information and/or state data to determine whether a mute state or an unmute state of the electronic device 130 is to be maintained or changed where the mute state entails suspending or preventing applications from utilizing the audio output device 230 as indicated in a stored settings and the unmute state entails enabling all applications from utilizing the audio output device 230. The method 300 will be described with regard to the system 100 of FIG. 1 and the electronic device 130 of FIG. 2.

In step 305, the electronic device 130 determines a prior state of the user 105. For example, when the electronic device 130 is first activated, the state of the user 105 may be determined from the monitored information being received and/or the state data being received from the measuring device 110, the sensor 115, or from the further electronic device 135. In another example, a previously determined, most current state (prior to a present moment) of the user 105 may indicate whether the state of the user 105 is awake or asleep. Such a previously determined state may have been stored in the memory arrangement 210.

In step 310, the electronic device 130 receives the monitored information and/or the state data from the various sources such as the measuring device 110, the sensor 115, the further electronic device 135 using any of the manners of data exchange such as through a direct wired or wireless connection (e.g., the measuring device 110), an indirect connection via the communications network 125 (e.g., the server 120), etc. Thus, the electronic device 130 may determine the current state of the user 105.

In step 315, the electronic device 130 determines whether there is a change in state of the user. For example, the prior state of the user 105 may have been awake and the state data may indicate that the current state of the user 105 is now asleep. In another example, the prior state of the user 105 may have been asleep and the monitored information may be used by the electronic device 130 to determine that the current state of the user 105 is still asleep.

If the electronic device 130 determines that there is no change in state, the electronic device 130 continues the method 300 to step 320. In step 320, the electronic device 130 maintains an audio output setting. For example, the prior state may indicate that the user 105 is awake. With no change in state, the current state is also that the user 105 is awake. Accordingly, the audio output setting associated with the prior state may be that all applications are enabled to utilize the audio output device 230. By maintaining the audio output setting, all the applications may still be enabled to utilize the audio output device 230. In another example, the prior state may indicate that the user 105 is asleep. In a substantially similar manner, the audio output setting associated with this prior state of the user 105 being asleep may prevent the application from utilizing the audio output device 230 (while considering any exception that may be in effect).

Returning to step 315, if the electronic device 130 determines that there is a change in state, the electronic device 130 continues the method 300 to step 325. In step 325, the electronic device 130 changes the audio output setting. For example, the prior state may indicate that the user 105 is asleep. With the change in state, the current state may be that the user is awake. Thus, the audio output setting may now enable all the applications to utilize the audio output device 230 when previously in the prior state the mute mechanism was in effect. In another example, the prior state may indicate that the user 105 is awake. With the change in state, the current state may be that the user is asleep. Thus, all the applications that were allowed to utilize the audio output device 230 may not be prevented from using the audio output device 230 as the settings indicate this feature while the user 105 is asleep.

It should be noted that the above description indicating that all of the applications being allowed to utilize the audio output device 230 is representative of using the audio output device 230 as indicated by any manual setting. For example, the user 105 may have muted a messaging application such that no audio sound is ever played. Thus, the messaging application being allowed to use the audio output device 230 still effectively results in no audio sound playing as the user 105 has preset this option. Therefore, when all the applications are allowed to use the audio output device 230, it is still subject to any predetermined settings chosen by the user 105.

It should again be noted that the exemplary embodiments relating to controlling an audio output device is only exemplary. Thus, the exemplary embodiments may be utilized for a different device, a functionality, an operation, etc.

The exemplary embodiments provide a device, system, and method of automatically controlling an audio output device based upon a state of a user. The exemplary embodiments may be configured to determine the state of the user based upon monitored information of the user or from receiving state data from a further electronic device. Based upon the state of the user, an audio output setting may be initiated or maintained based upon whether the user is awake or asleep.

It should be noted that the electronic device according to the exemplary embodiments may be used in any environment. For example, the electronic device may be a personal device of the user such as a personal cell phone. Thus, the exemplary embodiments may be used in a personal capacity as desired. In another example, the electronic device may be an enterprise device of the user associated with a particular enterprise such as a personal digital assistant (PDA). Thus, the exemplary embodiments may be used based upon requirements imposed by the enterprise (e.g., an overriding signal that unmutes the electronic device despite having been automatically muted for the user falling asleep). In a further example, the electronic device 130 may be associated with a contact center where the user 105 is an agent of the contact center. Thus, the exemplary embodiments may be used based upon requirements of the contact center (e.g., an overriding signal that may mute or unmute the electronic device based upon an availability such as an all-day, 24 hour availability and based upon an availability schedule of the agent).

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. An electronic device, comprising:
an audio output device configured to play a sound; and
a processor configured to receive state data indicative of a state of a user of the electronic device, the processor configured to control an activation of the audio output device based upon the state data, the activation of the audio output device being based upon first setting data when the state data indicates a first state, the activation of the audio output device being based upon second setting data when the state data indicates a second state.

2. The electronic device of claim 1, further comprising:
a transceiver configured to establish a connection with a further electronic device at least one of directly and through a communications network.

3. The electronic device of claim 2, wherein the state data is received from the further electronic device via the transceiver.

4. The electronic device of claim 2, wherein the processor is configured to determine the state data based upon monitored information of the user received from the further electronic device via the transceiver.

5. The electronic device of claim 1, wherein the first state is awake and the second state is asleep.

6. The electronic device of claim 5, wherein the first setting data indicates the audio output device is allowed for use by applications executed by the processor.

7. The electronic device of claim 5, wherein the second state indicates the audio output device is prevented for use by applications executed by the processor.

8. The electronic device of claim 7, wherein the audio output device is prevented for use with at least one exception, the exception being at least one of an application that is still allowed to use the audio output device, an operation that is still allowed to use the audio output device, a contact of the user in which an operation associated with the contact is still allowed to use the audio output device, and based upon a dynamic determination.

9. The electronic device of claim 1, wherein the state data is based upon further state data of a further user of the further electronic device.

10. The electronic device of claim 1, wherein the electronic device is an agent device and the user is an agent of a contact center.

11. A method, comprising:
receiving state data indicative of a state of a user of the electronic device; and
controlling an activation of an audio output device of the electronic device based upon the state data, the activation of the audio output device being based upon first setting data when the state data indicates a first state, the activation of the audio output device being based upon second setting data when the state data indicates a second state.

12. The method of claim 11, further comprising:
establishing, by a transceiver of the electronic device, a connection with a further electronic device at least one of directly and through a communications network.

13. The method of claim 12, further comprising:
receiving the state data from the further electronic device via the transceiver.

14. The method of claim 12, further comprising:
receiving monitored information of the user from the further electronic device via the transceiver; and
determining the state data based upon the monitored information.

15. The method of claim 11, wherein the first state is awake and the second state is asleep.

16. The method of claim 15, wherein the first setting data indicates the audio output device is allowed for use by applications executed by the processor.

17. The method of claim 15, wherein the second state indicates the audio output device is prevented for use by applications executed by the processor.

18. The method of claim 17, wherein the audio output device is prevented for use with at least one exception, the exception being at least one of an application that is still allowed to use the audio output device, an operation that is still allowed to use the audio output device, a contact of the user in which an operation associated with the contact is still allowed to use the audio output device, and based upon a dynamic determination.

19. The method of claim 11, wherein the state data is based upon further state data of a further user of the further electronic device.

20. A system, comprising:
a first electronic device of a user including an audio output device configured to play a sound and a first transceiver; and
a second electronic device configured to monitor information of the user, the second electronic device including a second transceiver, the first and second transceivers configured to establish a connection between the first and second electronic devices one of directly and through a communications network,
wherein the second electronic device transmits the monitored information of the user to the first electronic device via the connection,
wherein the first electronic device is configured to determine state data of the user based upon the monitored information, the state data indicative of a state of the user, the state being one of asleep and awake,
wherein the first electronic device is configured to control an activation of the audio output device based upon the state data, the activation of the audio output device being based upon first setting data when the state data indicates a first state, the activation of the audio output device being based upon second setting data when the state data indicates a second state.
